(19) United States
(12) Patent Application Publication
(10) Pub. No.: US 2009/0193757 A1
(43) Pub. Date: Aug. 6, 2009

(54) PROCESS AND APPARATUS FOR PRODUCING TOBACCO BAGS

(76) Inventor: Burkard Roesler, Blender (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/364,248

(22) Filed: Feb. 2, 2009

(30) Foreign Application Priority Data
Feb. 5, 2008 (DE) 102008007754.2

(51) Int. Cl. B65B 43/04; B65B 51/06; B65B 43/42; B31B 19/00; B65B 51/10

(52) U.S. Cl. 53/138.1; 493/267; 493/196; 493/248; 53/550; 53/389.4; 53/562

(57) ABSTRACT

In order to produce tobacco bags from sheet material having a pocket and a fold-over flap and a tape as closure means, the tape is applied (as are possibly further applications) to a continuous sheet-material web (22) for producing the bags by transversely directed severing cuts. The procedure here is such that the sheet-material web (22) is provided in the first instance, by folding, with a continuous web leg and then with transversely directed connecting seams in the region of the web leg, and thereafter the tape is applied to the sheet-material web prepared in this way. Bags (10) provided with a tape are then severed from the sheet-material web. The tapes are applied to the sheet-material web (22) in the region of an application station (30). Following this, the bags (10) are severed in a severing station (27).

### STATEMENT OF RELATED APPLICATIONS

This application claims the benefit under 35 USC 119 of German patent application number 10 2008 007 754.2 having a filing date of 5 Feb. 2008, which is incorporated herein in its entirety by this reference.

### BACKGROUND OF THE INVENTION

### 1. Technical Field

The invention relates to a process for producing tobacco bags from sheet material having a pocket which is bounded or closed by lateral seams—side seams— and which has an opening with a closure flap, in particular a fold-over flap, it being the case that a continuous sheet-material web is folded over in the longitudinal direction to form a web leg, is then provided with transversely directed connecting seams in the region of the web leg and, finally, the bags are severed from the web, by transversely directed severing cuts in the region of the double-width connecting seams, filled and closed, and that separate blanks, in particular closure means such as tape, touch-and-close fastener strips and/or printing carriers or coupons and/or stickers for fixing inserts, are applied to the bag by adhesive bonding. The invention also relates to an apparatus for carrying out the process.

### BRIEF SUMMARY OF THE INVENTION

The bags in question here serve for accommodating a portion of cut tobacco. Once the pocket has been filled, the fold-over flap is folded around the pocket and fixed on a rear pocket wall by a retaining means, in particular by a tape. The issue here is that of improved production of bags of this or a similar type along with better performance of the machines used.

Accordingly, the object of the invention is to improve the production of (tobacco) bags of the configuration mentioned in the introduction, or of a similar configuration, in respect of performance without quality being adversely affected.

In order to achieve this object, the process according to the invention is characterized in that the separate blank or blanks is or are applied to the bag, in particular to the fold-over flap and/or to a front pocket wall, prior to the bag being filled, and in that the bag is then filled and closed.

In particular, the abovementioned blanks are applied to the (sheet-material) web, namely fixed by adhesive bonding, in the relative position appropriate for the finished bag. Thereafter, the bags having the respectively necessary blanks are severed from the web by transversely directed severing cuts. The web is expediently first of all folded in longitudinal direction to form the web leg. Thereafter, the transversely directed connecting seams are provided and then adhesive bonding is used to fasten the separate blanks on the web prepared in this way.

The apparatus according to the invention is provided with a folding station for continuously folding over the web to form the web leg during continuous transportation, with a downstream sealing station for providing the transversely directed connecting seams, with a blank station/application station for applying the respectively necessary blanks, in particular for applying a tape for each bag, with a downstream severing station for severing the bags from the web and, finally, with a filling and closing station. The design of the blank station and of the downstream severing station is special.

### BRIEF SUMMARY OF THE DRAWINGS

Details of the process and of the apparatus are explained more specifically hereinbelow with reference to the drawings, in which:

FIG. 1 shows a perspective illustration of an open bag which has not been filled.

FIG. 2 shows a bag according to FIG. 1 following the filling and closing operations.

FIG. 3 shows a simplified schematic illustration, in perspective, of an apparatus for producing and filling bags.

FIG. 4 shows, on an enlarged scale, a detail of the apparatus according to FIG. 3 in a side view according to arrow IV in FIG. 3.

FIG. 5 shows, likewise in side view, the detail according to FIG. 4, or the station illustrated thereby, in a different configuration.

FIG. 6 shows, on a further-enlarged scale, a sub-region of the apparatus according to FIG. 4.

FIG. 7 shows, on an enlarged scale, a detail of FIG. 6, namely a section along plane VII-VII from FIG. 6.

FIG. 8 shows the detail according to FIG. 4 in a transverse view or in a section along plane VIII-VIII from FIG. 4.

FIG. 9 shows a detail of the apparatus according to FIG. 6 in a cross section IX-IX from FIG. 6.

FIG. 10 shows, on an enlarged scale, a part X of the detail according to FIG. 8.

FIG. 11 shows a partial view analogous to FIG. 6, but of another embodiment of the relevant stations.

FIG. 12 shows, on an enlarged scale, a detail of the subassembly according to FIG. 11, namely a partial section along section plane XII-XII from FIG. 11.

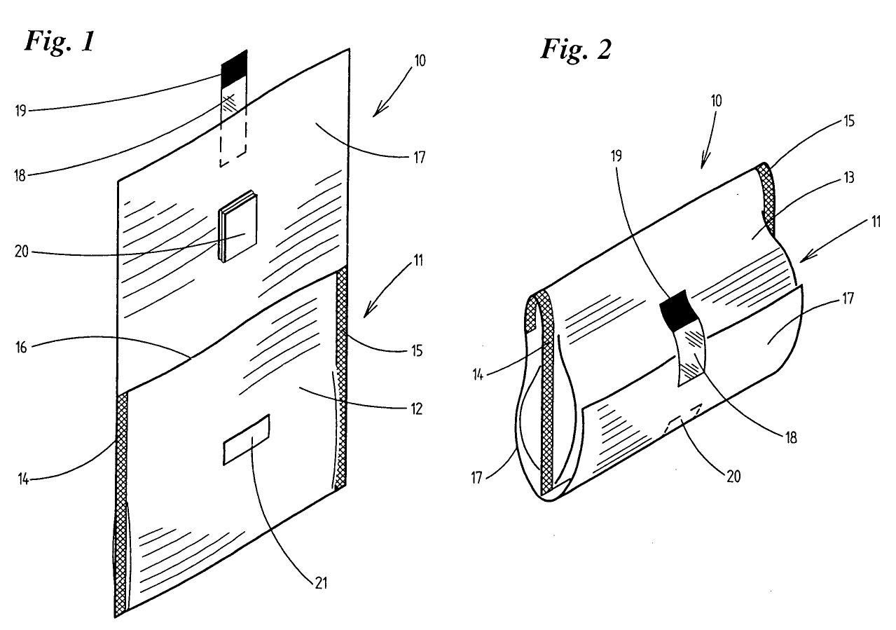

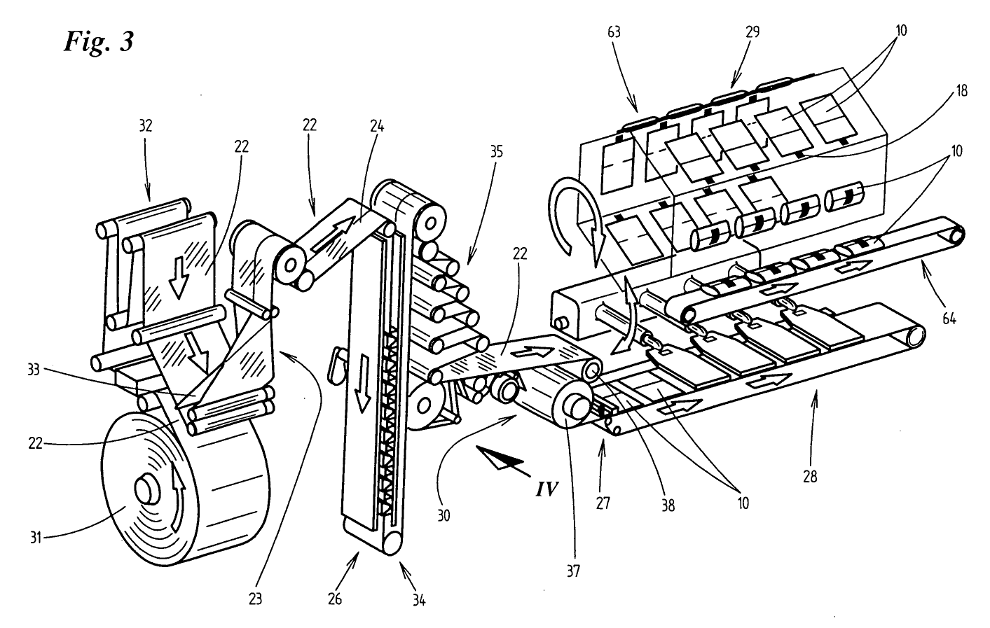

### DETAILED DESCRIPTION OF PREFERRED EMBODIMENTS

The invention deals predominantly with the production, filling and completion of bags 10 made of thin packaging material, in particular (thermally sealable) sheet material. The bag 10 comprises a single piece, in this case rectangular, elongate blank which, on account of a leg being folded over, forms a pocket 11 for the pack contents, the pocket having a front pocket wall 12 and a rear pocket wall 13. These abutting regions of the blank are connected to one another by thermal welding or adhesive bonding, to be precise by side seams 14, 15. An opening 16 allows the pocket 11 to be filled and the contents to be removed. The rear pocket wall 13 is extended beyond the opening 16 and forms a closure flap or a fold-over flap 17. If the pocket 11 has been filled and closed, if appropriate, in the region of the opening 16 by closing strips, this fold-over flap is folded around the pocket such that an end region of the fold-over flap 17 butts against the rear pocket wall 13 and is connected thereto.

The bag 10 is provided with applications or blanks fastened by adhesive bonding, if appropriate also by thermal sealing (welding). In the case of the present example, as closure means of the bag 10 a tape 18 is applied—approximately centrally— to the free periphery of the fold-over flap 17. The strip-like closure means has a permanent-adhesive coating on one side and an adhesive-free grip tab 19 at the free end region.

Also in the case of this example, a printing carrier or a coupon 20 (folded a number of times), in other words an advertising or information carrier, is applied to the bag 10. The coupon 20 is fixed, approximately centrally, on the inside of the fold-over flap 17 by adhesive bonding.

A device for retaining inserts, to be precise a rectangular retaining piece, namely a sticker 21, is also applied to the bag 10. This sticker has an adhesive-bonding surface on both sides, that is to say for fastening on the bag 10 and for applying inserts, in particular a pack with cigarette paper. The sticker 21 here is applied to the outside of the front pocket wall 12.

One special feature consists in the fact that the abovementioned applications 18, 20, 21 are applied to the bag 10 before the latter is filled and closed. The finished, but unfilled bags 10 are created by severing from a continuous (sheet-)material web 22. The latter is provided, during continuous transportation, in a folding station 23, with a longitudinal fold, namely with a continuous web leg 24, which forms the front pocket wall 12 of the bag 10. Thereafter, transversely directed connecting seams 25 are provided in the region of the folded sheet-material web 22 in a sealing station 26. The connecting seams 25 are double the width of the side seams 14, 15. In a downstream severing station 27, the bags 10 according to FIG. 1 are severed from the sheet-material web 22 by transversely directed severing cuts, to be precise they are severed centrally in the region of a connecting seam 25, and the latter is therefore divided into two adjacent side seams 14, 15. The individual bags 10 are fed to a transfer station 28 and, in the region of the same, are transferred to a filling and closing station 29.

The separate blanks 18, 20, 21 are applied to the sheet-material web 22 in an appropriate position. An application station 30 is preferably positioned between the sealing station 26 and the severing station 27. Accordingly, the blanks, at least the tape 18, are/is applied to the sheet-material web 22 once the pockets 11 have been defined by the connecting seams 25.

An apparatus for producing, filling and closing the bags 10 is characterized by a compact grouping of subassemblies. The (non-folded) sheet-material web 22 is drawn off from a reel 31 with a horizontal axis of rotation and fed to the folding station 23 via a compensating pendulum arrangement 32. A stationary, essentially triangular folding device 33 (folding diverter) forms the web leg 24 during continuous transportation of the sheet-material web 22. At the same time, the sheet-material web 22 is deflected through 900 into a main conveying direction. The compensating pendulum arrangement 32 serves to compensate for different rotational speeds of the reel 31 and to provide for a constant, continuous conveying speed in the region of the folding station 23.

The sheet-material web 22 prepared in this way is directed, via deflecting and drive rollers, through a sealing subassembly 34 in order for the connecting seams 25 to be provided. The sealing subassembly 34 is arranged in an upright state. The sheet-material web 22 is introduced into the sealing subassembly 34 at a top end and, once the connecting seams 25 have been provided by means of transversely directed and transversely movable sealing and/or welding devices, is guided out of the sealing subassembly 34 at the bottom end. The sheet-material web 22 is then guided further upwards and directed through a further compensating pendulum arrangement 35. In the region of the sealing subassembly 24, the web 22 is driven cyclically. The downstream stations are likewise geared to cyclic conveying of the sheet-material web 22, but with conveying cycles which differ from that in the region of the sealing subassembly 34. These different movements are compensated for by the compensating pendulum arrangement 35.

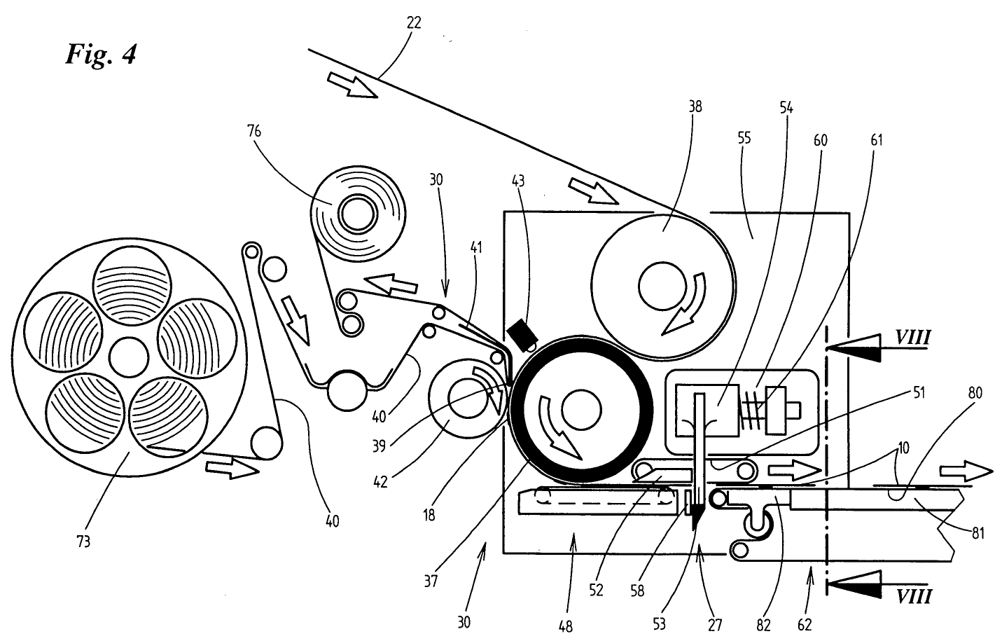

The application station 30 is equipped with an application subassembly, for example a tape subassembly 36, of which an advantageous exemplary embodiment is shown in FIG. 4. The operation of applying one or more blanks 18, 20, 21 takes place in the region of a deflection of the sheet-material web 22, namely along a circumference of an application roller 37. The sheet-material web 22 is guided along an obliquely downwardly directed conveying section via a deflecting roller 38 and positioned on the circumference of the application roller 37. A wrap-around angle is more than half the circumference. An S-shaped movement path of the sheet-material web 22 is achieved in conjunction with the deflecting roller 38.

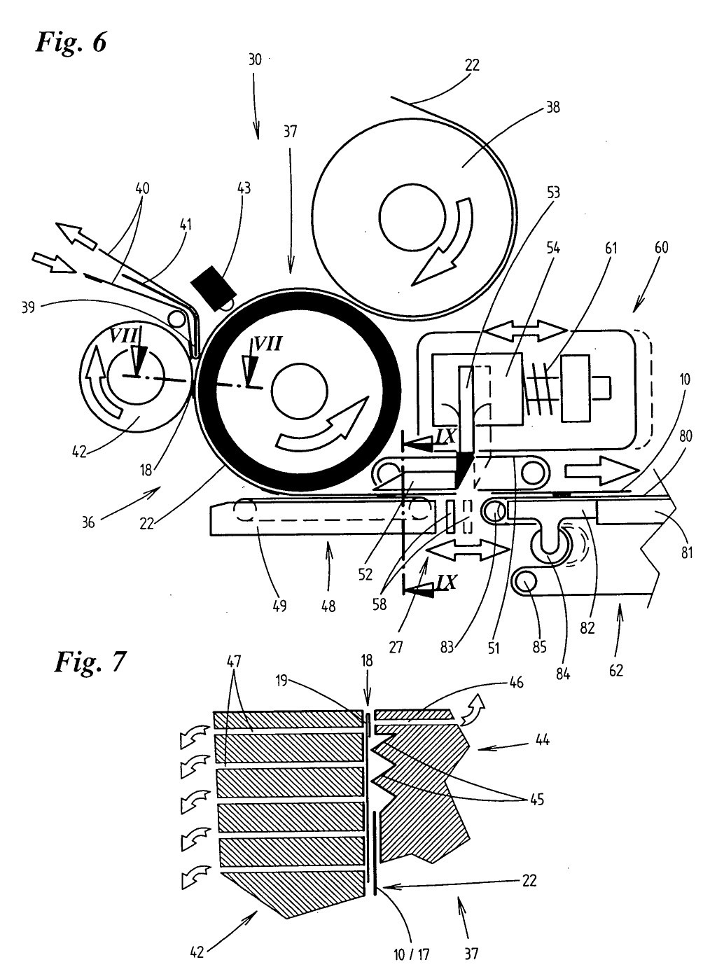

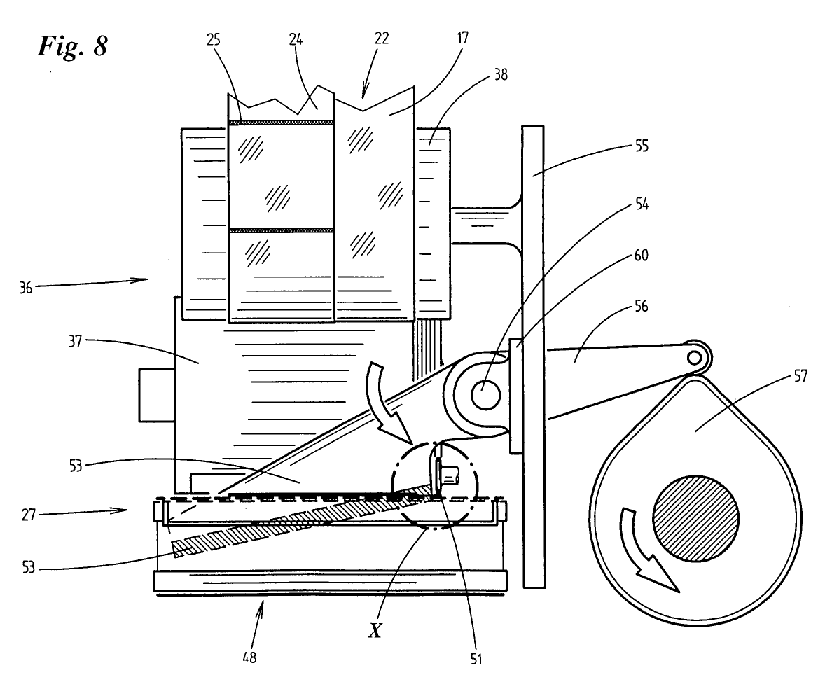

In the case of the example according FIG. 4, the tape subassembly 36 is assigned to the application roller 37. The tapes 18 are positioned on a carrier web 40, to be precise with the longitudinal extent of the tape 18 transverse to the strip-like carrier web 40. This carrier web is drawn off from a roll and fed, via deflecting rollers, to the circumference of the application roller 37. In the region of a sharp-edged deflection 39 of the carrier web 40, a respective tape 18 is drawn off from the carrier web 40 by peeling and is received by a pressure-exerting roller 42 for application to the bag 10 or to the sheet-material web 22 on the circumference of the application roller 37. As can be seen from FIG. 6, the procedure is preferably such that the carrier web 40 is guided around a free edge of a deflecting wall 41, that is to say around a comparatively sharp edge. The tape 18 which becomes free in the process is applied to the sheet-material web 22 by a pressure-exerting device or by the pressure-exerting roller 42, to be precise with relative positioning corresponding to FIG. 1, that is to say in the region of a free periphery of the fold-over flap 17 and with the projecting portion shown. The precise positioning of the tape 18 is controlled by an optoelectronic sensing device 43 with the aid of printed marks on the sheet-material web 22. The application roller 37 is set up, at the same time, as a drive roller for the sheet-material web 22, preferably with a servodrive. The sheet-material web 22 is positioned in the region of the blank subassembly such that the side with the web leg 24 butts against the application roller 37. Accordingly, that side of the tape 18 which is provided with glue is directed towards the application roller 37.

In order for the tape 18 to be applied correctly to the sheet-material web 22, the application roller 37 is extended axially beyond the region of the bag 10, or of the fold-over flap 17, and is designed with a special peripheral region 44 intended for accommodating or supporting the projecting region of the tape 18. The latter has its free adhesive-bonding side butting against the peripheral region 44, which exhibits a low retaining force and is provided with pointed or sharp-edged protrusions 45, in particular encircling ribs. The adhesive-bonding surface of the tape 18 butts in an easily releasable manner against the points. The adhesive-free grip tab 19 butts against a cylindrical peripheral surface of the application roller 37 and is retained here by radial suction bores 46, that is to say by negative pressure.

The pressure-exerting roller 42, which is located opposite, is likewise provided with means for retaining the tape 18 until it is transferred to the application roller 37, that is to say it is provided with a plurality of radial suction bores 47 connected to a negative-pressure source.

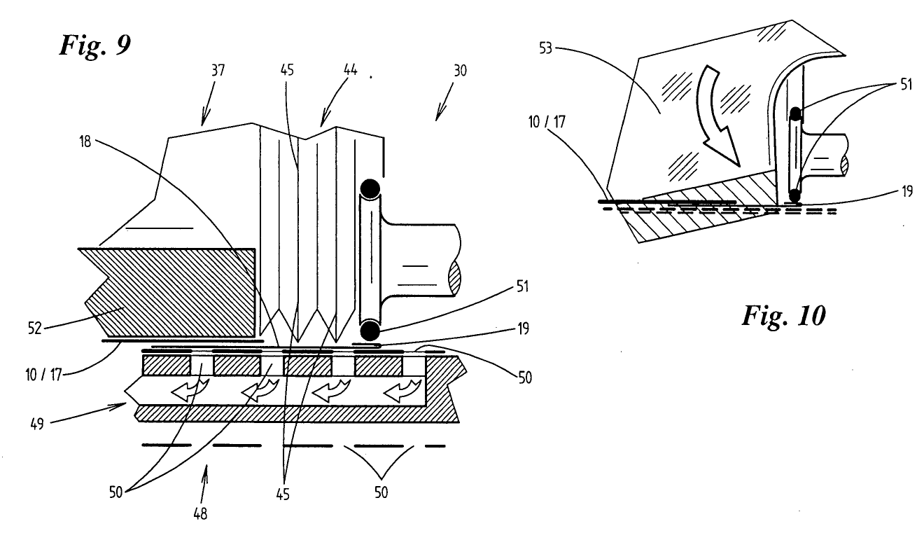

In the bottom region of the application roller 37, the sheet-material web 22 provided with the tapes 18 (or other blanks) is transported further in a horizontal plane and fed to a severing device 48 of the severing station 27. The sheet-material web 22 is deposited on a conveyor, in particular on an intermediate conveyor 48 designed as a suction belt. This intermediate conveyor guides the sheet-material web 22 right up to a severing plane. The design of the intermediate conveyor 48 is special (FIG. 9). It comprises a suction box 49 beneath a top strand, or conveying strand, of the intermediate conveyor 48. The suction box 49 is connected to a negative-pressure source. A top wall, against which the conveying strand of the intermediate conveyor 48 butts, is provided with a plurality of suction holes 50. The intermediate conveyor 48 either is of air-permeable design throughout or is provided with a plurality of distributed suction holes which correspond with the suction holes 50 at the suction box 49. Accordingly, the sheet-material web 22 is removed from the circumference of the application roller 37 by the intermediate conveyor 48, on account of the suction air, and fed to the downstream severing subassembly in a state in which it is fixed in a horizontal plane.

In order to ensure reliable guidance of the tape 18, the application roller 37 is followed, above the receiving conveyor 48, by a strip conveyor which acts in the region of the grip tab 19 of the tape 18. This is a round belt 51, which has a bottom conveying strand butting against the grip tab 19. The conveyor or round belt 51 extends from a region directly adjacent to the application roller 37 into the region of a continuing conveyor for the severed bags 10, namely into the region above a bag conveyor 62. The round belt 51 runs—in the lateral region—through the severing station 27.

Fitted in a stationary manner alongside the round belt 51, above the receiving conveyor 48, is a supporting device for the sheet-material web 22, namely a guide component 52 which tapers in a wedge-shaped manner on the side directed towards the application roller 37 and, opposite this, extends precisely as far as the severing plane. The planar or plate-like guide component 52 prevents the sheet-material web 22 from warping once it has left the application roller 37.

A severing device acts cyclically in the region of the severing station 27 and executes a severing cut, approximately centrally in the region of the connecting seam 25, transversely over the entire width of the sheet-material web 22. The severing device comprises a severing blade 53 which is mounted in a pivotable manner outside the region of the sheet-material web 22. Accordingly the severing blade 53 executes a severing cut as a pivoting movement made in an upright plane. The severing blade can be pivoted about a pivot bearing 54 which is mounted preferably in a displaceable manner on a carrying wall 55 of the machine framework. An actuating gear mechanism provides for the coordinated movement of the severing blade 53 up and down. For this purpose, an actuating arm 56 with a contact roller can be actuated by a revolving cam plate 57. The severing blade 53 and actuating arm 56 act as a two-armed lever. The movement amplitude of the severing blade 53 is such that an entire severing cut is executed. An abutment blade 58 interacts with the severing blade 53. This abutment blade is designed as a fixed, transversely directed cutting component. The severing blade 53 and abutment blade 58 together give rise to a scissors-like cutting operation by way of the pivoting movement of the severing blade 53. The abutment blade 58 is arranged beneath the plane of the sheet-material web 22.

The severing blade 53 or the pivot bearing 54 is fitted in a displaceable manner on the carrying wall 55, in order that the cutting or severing plane can be adjusted. This makes it possible to produce bags 10 of different widths. The abutment blade 58 is displaced along therewith as the unit. For this purpose, the pivot bearing 54 is fitted on a carrier 60 which is mounted in a displaceable manner, in particular on the carrying wall 55. The severing blade 53 or the pivot bearing 54 is forced, by the pressure of a spring 61, in the direction of the abutment blade 58, and this means that a precise cut is always ensured.

The severed bags (including tape 18) are received by a connection conveyor, namely the bag conveyor 62. The latter transports the bags 10, at a spacing apart from one another, into the region of the transfer station 28. In the latter, the bags 10 are gripped one after the other and transferred to a filling and closing subassembly, namely to a bag turret 63. The arrangement is such that a plurality of, in the present case four, bags 10 are simultaneously positioned on the bag conveyor 62, gripped and transferred to the bag turret 63. The filled and closed bags are deposited on a removal conveyor 64 and removed.

For the displacement of the cutting or severing plane in the severing station 27, it is also possible to adjust the bag conveyor 62 or an initial region which is directed towards the severing station 27. The bag conveyor 62 is designed as a suction conveyor for fixing the bags 10 to a sufficient extent on a top strand 80. Arranged beneath the same is a suction box 81, for applying negative pressure to the top strand 80. The suction box 81 is designed telescopically, that is to say with a telescoping box 82, in order to provide for displacement of the accommodating end of the bag conveyor 62. This telescoping box extends as far as a top deflecting roller 83 for the top strand 80. The relative positioning always remains the same since the telescoping box 82 enters into the suction box 81 to a more or less great extent. The telescoping box 82 is also designed as a negative-pressure source for the top strand 80, and this ensures that the bags 10 are secured as far as the deflecting roller 83. Furthermore, the belt of the bag conveyor 62 is guided around a compensating roller 84, which in the case of the present exemplary embodiment is connected to the telescoping box 82, but can always be moved therewith. This means that the tensioning in the belt of the bag conveyor 62 is maintained even upon displacement of the accommodating end. A further deflecting roller 85 is provided beneath the compensating roller in order to guide the belt into the bottom strand and receive it therefrom.

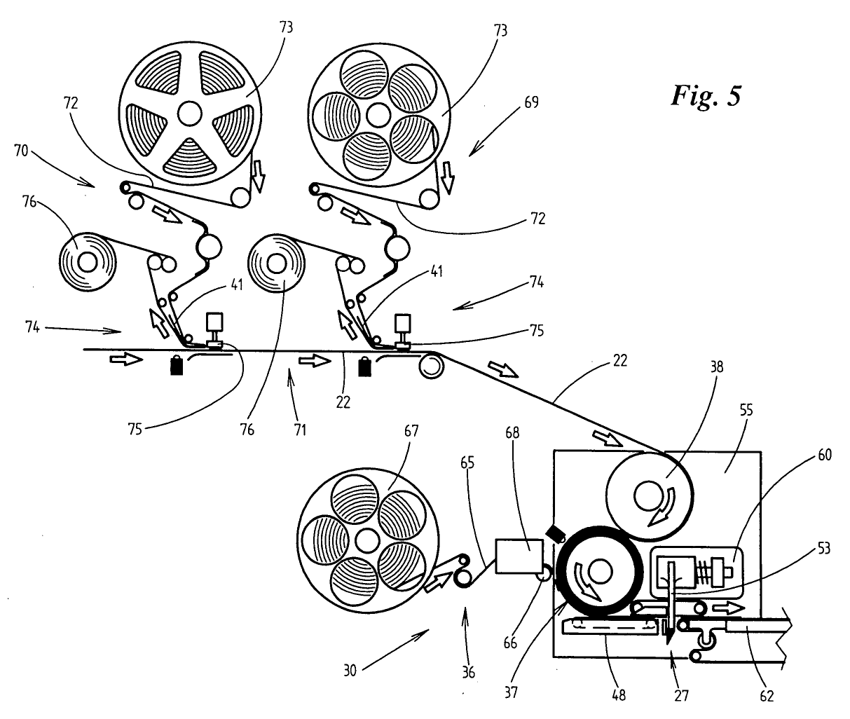

The application station 30 may be designed such that, rather than just one closure means (tape 18), further blanks can be applied to the bags 10 or the prepared sheet-material web 22. In the case of the exemplary embodiment according to FIG. 5, a tape 18 is applied to the sheet-material web 22 by a modified application subassembly 36. Provision is also made for two further blanks, to be precise for example a sticker 21 and a coupon 20 or folding coupon, to be applied.

It is also the case here that the application subassembly 36 is assigned to an application roller 37, over the circumference of which is transported the sheet-material web 22 which has been prepared in the manner described. The tapes 18 are severed from a continuous tape web 65 by transversely directed severing cuts and positioned precisely, by a feed roller 66, on the sheet-material web 22, as described in conjunction with FIGS. 4 and 6. The tape web 65 is drawn off from a roll 67. A cutting mechanism 68, which is only schematically illustrated, separates off transversely directed tapes 18 one after the other from the corresponding tape web 65. The latter is provided on one side (top) with permanent adhesive and, along the periphery, with a continuous adhesive-free strip for forming the grip tab 19.

A coupon subassembly 69 and sticker subassembly 70 are arranged upstream of the application subassembly 36 as seen in the transporting direction. The subassemblies 69 and/or 70 are/is positioned in the region of a horizontal web portion 71, above the application subassembly 36. The subassemblies 69 and 70 are of largely corresponding design. The coupons 20, on the one hand, and the stickers 21, on the other hand, are respectively arranged on a carrier web 72. This is drawn off from a roll 73. In a manner analogous to the exemplary embodiment according to FIGS. 4 and 6, the carrier web 72 is directed, via deflecting rollers, as far as an application location 74. In this region, the carrier web 72 is deflected over a sharp edge, to be precise in a region directly above the sheet-material web 22. In the region of a deflecting wall 41, the relevant blank 20, 21 is peeled off from the carrier web 72 and exposed. A pressure-exerting device, namely a ram 75 which can be moved up and down, presses the relevant blank, with a glue surface directed downwards, onto the sheet-material web 22. The stripped carrier web 72 is wound up to form a stripped-web reel 76.

The sheet-material web 22 is transported in the region of the subassemblies 69, 70 such that the front pocket wall 12 or the web leg 24 is directed upwards, that is to say is exposed. In the case of the arrangement of the blanks 20, 21 on the bag which is used by way of example (FIG. 1), the subassemblies 69, 70 are offset in relation to one another in the transverse direction of the sheet-material web 22, the coupon subassembly 69 being positioned approximately centrally in relation to the web region of the fold-over flap 17 and the sticker subassembly 70 being positioned approximately centrally in relation to the web leg 24.

The subassemblies 69, 70 operate with cyclic advancement of the sheet-material web 22. As an alternative to the configuration according to FIGS. 4 and 6, the application subassembly 36 for the tape 18 may likewise be positioned in the region of a horizontal web portion 71. However, in the case of such a variant, the sheet-material web 22 has to be turned upstream of a tape subassembly 36 in order for the tape 18 to be applied to the sheet-material web 22 in the correct position. It is also the case with the design of the tape subassembly 36 analogous to FIG. 5 that the tape can be applied to the application roller 37 by means of a ram, in a manner corresponding to the subassemblies 69, 70. In the case of this variant, the sheet-material web 22 has to be at a standstill as the tape is being applied.

It is generally the case, in respect of the movement characteristics of the sheet-material web 22, that, in a tape subassembly 36 with a rotating application device, the sheet-material web is transported as the tape 18 is being applied, but is otherwise halted cyclically in order for the severing cut to be executed in the region of the severing station 27.

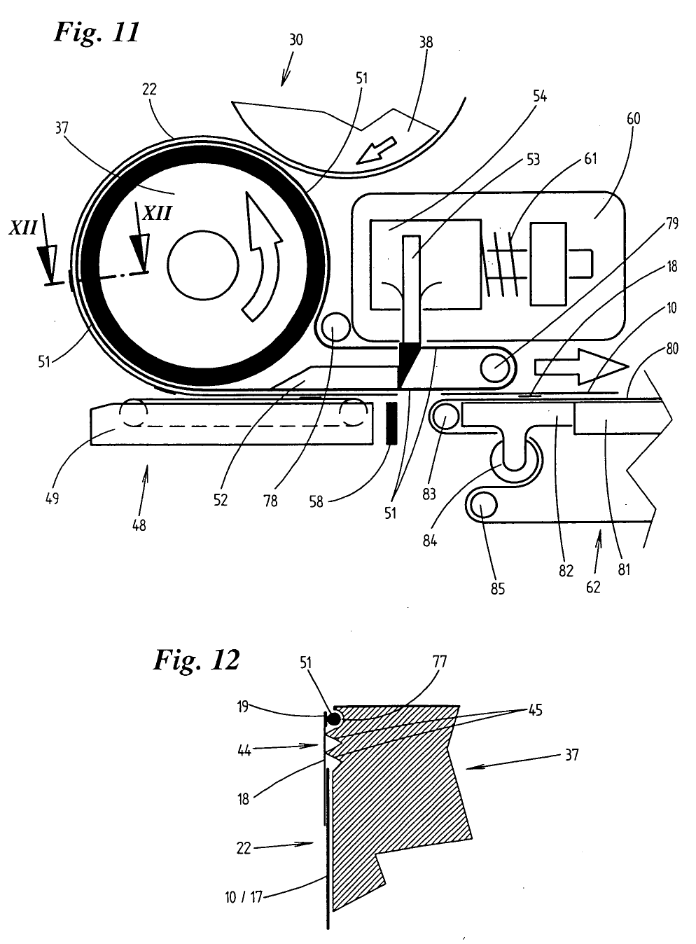

FIG. 11 shows a possible variant of the application station 30 according to the exemplary embodiment of FIGS. 4 and 6. In the case of the exemplary embodiment of FIG. 11, the separate guiding and conveying device for the laterally projecting leg of the tape 18, in particular the round belt 51, is combined with the application roller 37. The latter is provided, in the peripheral region 44 (FIG. 12), with a guide groove 77, in which the round belt 51 runs and is guided. The groove 77 has an approximately semicircular cross section and lies directly against the periphery of the application roller 37 and/or in the region of the grip tab 19. Alongside the same are formed the already described protrusions 45, against the edges of which the adhesive-coated, exposed region of the tape 18 butts. In the case of this exemplary embodiment, the round belt 51 wraps virtually all the way around the application roller 37. A deflecting roller 78 guides a top strand back into the horizontal running direction as far as a further deflecting roller 79, which is located directly above the movement plane of the bags 10 and is aligned with the circumference of the application roller 37.

### LIST OF DESIGNATIONS

| | |
|---|---|
| 10 | Bag |
| 11 | Pocket |
| 12 | Front pocket wall |
| 13 | Rear pocket wall |
| 14 | Side seam |
| 15 | Side seam |
| 16 | Opening |
| 17 | Fold-over flap |
| 18 | Tape |
| 19 | Grip tab |
| 20 | Coupon |
| 21 | Sticker |
| 22 | Sheet-material web |
| 23 | Folding station |
| 24 | Web leg |
| 25 | Connecting seam |
| 26 | Sealing station |
| 27 | Severing station |
| 28 | Transfer station |
| 29 | Filling and closing station |
| 30 | Application station |
| 31 | Reel |
| 32 | Compensating pendulum |
| | arrangement |
| 33 | Folding device |
| 34 | Sealing subassembly |
| 35 | Compensating pendulum |
| | arrangement |
| 36 | Tape subassembly |
| 37 | Application roller |
| 38 | Deflecting roller |
| 39 | Deflection |
| 40 | Carrier web |
| 41 | Deflecting wall |
| 42 | Pressure-exerting roller |
| 43 | Sensing device |
| 44 | Peripheral region |
| 45 | Protrusion |
| 46 | Suction bore |
| 47 | Suction bore |
| 48 | Intermediate conveyor |
| 49 | Suction box |
| 50 | Suction holes |
| 51 | Round belt |
| 52 | Guide component |
| 53 | Severing blade |
| 54 | Pivot bearing |
| 55 | Carrying wall |
| 56 | Actuating arm |
| 57 | Cam plate |
| 58 | Abutment blade |
| 59 | Pivoting body |
| 60 | Carrier |
| 61 | Spring |
| 62 | Bag conveyor |
| 63 | Bag turret |
| 64 | Removal conveyor |
| 65 | Tape web |
| 66 | Feed roller |
| 67 | Roll |
| 68 | Cutting mechanism |
| 69 | Coupon subassembly |
| 70 | Sticker subassembly |
| 71 | Web portion |
| 72 | Carrier web |
| 73 | Roll |
| 74 | Application location |
| 75 | Ram |
| 76 | Stripped-web reel |
| 77 | Guide groove |
| 78 | Deflecting roller |
| 79 | Deflecting roller |
| 80 | Top strand |
| 81 | Suction box |
| 82 | Telescoping box |
| 83 | Deflecting roller |
| 84 | Compensating roller |
| 85 | Deflecting roller |

What is claimed is:

1. A process for producing tobacco bags (10) from sheet material having a pocket (11) which is bounded or closed by lateral side seams (14, 15) and which has an opening (16) with a closure flap (17), comprising
folding over a continuous sheet-material web (22) in the longitudinal direction to form a web leg (24), then
providing the sheet-material web (22) with transversely directed connecting seams (25), then
severing the bags from the sheet-material web (22) by transversely directed severing cuts in the region of the connecting seams (25), then
applying separate blanks, selected from the group consisting of tape (18), printing carriers, coupons (20), and stickers (21) for fixing inserts, to the bag (10) by adhesive bonding, wherein the separate blanks are applied to the insides of the fold-over flap (17) and/or to a front pocket wall (12) of the bag (10), and then
filling and closing the bags.

2. The process according to claim 1, wherein the separate blanks (18, 20, 21) are applied to the sheet-material web (22) in an appropriate relative position following the formation of the transversely directed connecting seams (25), and wherein, thereafter, bags (10) with the separate blanks (18, 20, 21) are severed from the sheet-material web (22) by transversely directed severing cuts.

3. The process according to claim 1, wherein the separate blanks (18, 20, 21) are applied to the sheet-material web (22) in the region of a deflection of the sheet-material web (22) along the circumference of an application roller (37), the sheet-material web having the web leg (24) directed inwards.

4. The process according to claim 1, wherein the separate blanks (18, 20, 21) are applied to the sheet-material web (22) in the region of a horizontally guided portion (21) of the sheet-material web, and wherein a tape subassembly (36) and/or a coupon subassembly (69) and/or a sticker subassembly (70) is arranged above the sheet-material web (22) on the side of the sheet-material web (22) that has the web leg (24).

5. The process according to claim 3, wherein, in the region of an tape subassembly comprising the application roller (37), driven in rotation, and with a likewise movable pressure-exerting roller (42) and/or feed roller (66), for applying the tape (18) to the sheet-material web (22), the sheet-material web (22) is conveyed continuously during application of the tape (18), but is otherwise conveyed cyclically in the region of a downstream severing station (27).

6. The process according to claim 1, wherein a portion of the tape (18) applied to the sheet-material web (22) projects laterally and is guided and supported in the region of the projecting portion during transportation.

7. An apparatus for producing tobacco bags (10) from a continuous web of packaging material by severing the bags (10) from a continuous sheet-material web (22), wherein
means for providing the sheet-material web (22) with a web leg (24), the web leg (24) being formed by folding,
a welding and/or sealing subassembly (34) for providing the web leg (24) with transversely directed connecting seams (25),
means for executing a severing cut for forming the bags (10), the severing cut being executed in the region of the connecting seam so as to create bags (10) with an open pocket (11), with side seams (14, 15) in the region of the pocket (11) and with a fold-over flap (17), which can be fed to a filling and closing station (29),
an application station (30) for applying separate blanks (18, 20, 21) to the bags (10), and
a severing station (27) in which the bags (10) with the blanks (18, 20, 21) are severed from the sheet-material web (22).

8. The apparatus according to claim 7, further comprising
a web station with a reel (31) for the sheet-material web (22), the reel having a horizontal axis of rotation extending in a main conveying direction,
a folding station for continuously forming the web leg (24) of the sheet-material web (22) with deflection of the sheet-material web (22) through 90° in relation to the reel (31),
a downstream sealing station (26) with a welding and/or sealing subassembly (34) for the connecting seams (25),
an application station (30) for applying separate blanks (18, 20, 21) to the sheet-material web (22) in accordance with the position on the bag (10), and
a severing station (27) for severing bags (10) in the region of a respective connecting seam (25).

9. The apparatus according to claim 8, further comprising
a transfer station (28) with a bag conveyor (62), and
a filling and closing subassembly
wherein the severing station (27) is followed, in the same conveying direction, by the transfer station (28) with the bag conveyor (62) which holds a plurality of bags that are spaced apart from one another in a transfer position in order to transfer the bags, transversely to the main conveying direction, to the filling and closing subassembly, the filling and closing subassembly being a bag turret (63) with transversely directed rotatability, the bag turret (63) being mounted essentially in the region of the transfer station (28), above the bag conveyor (62).

10. The apparatus according to claim 7, further comprising an application subassembly for applying a blank (18, 20, 21), wherein the application station (30) is arranged upstream of the severing station (27), the application station (27) comprises the application subassembly, the application subassembly being at least one tape subassembly (36) for applying tapes (18), the tapes (18) having a permanent-adhesive coating on one side and a grip tab (19) at one end, to the sheet-material web (22) in the region of a free periphery assigned to the fold-over flap (17), such that the tape (18) has a portion, including the grip tab (19), projecting away laterally beyond the sheet-material web (22).

11. The apparatus according to claim 10, wherein, as the sheet-material web (22) buffs against the circumference of a deflecting roller or of an application roller (37) during momentary rotation of the same, the tape (18) is applied to the free outer side of the sheet-material web (22) by a pressure-exerting roller (42) or a feed roller (36) on the circumference of the application roller (37), whereby the tape (18) to be fed by the subassembly to the pressure-exerting roller (42) or feed roller (66) and to be gripped by the latter by means of suction air, is pressed onto the sheet-material web (22) during rotation of the application roller (37).

12. The apparatus according to claim 11, further comprising means for guiding and supporting the tape (18) located in an axial peripheral region on the application roller (37), the means for guiding and supporting the tape (18) being pointed or sharp-edged protrusions (45) for the easily releasable abutment of the free part of the tape (18) with the glued surface.

13. The apparatus according to claim 11, further comprising means for fixing the adhesive-free grip tab (19) are arranged on the outer axial periphery of the application roller (37), the means for fixing the adhesive-free grip tab (19) being suction bores (46) for gripping the grip tab (19) by means of suction air.

14. The apparatus according to claim 7, further comprising an intermediate conveyor (48), wherein, following application of the blank (18, 20, 21), the sheet-material web (22) is gripped by the intermediate conveyor (48) and transported to the severing station (27) by the intermediate conveyor (48), which is designed as a suction belt and of which a top strand of the belt is subjected to negative pressure for the purpose of fixing the sheet-material web (22).

15. The apparatus according to claim 7, further comprising a severing blade (53) located in the region of the severing station (27), the severing blade (53) being designed as a pivotable severing device which using a pivoting movement, together with a fixed abutment blade (58), executes a severing cut over the entire width of the sheet-material web (22).

16. The apparatus according to claim 14, further comprising a guide for the sheet-material web (22) that is provided at least in a sub-region above the intermediate conveyor (48), the guide (22) being a fixed, plate-like guide component that extends approximately as far as the severing plane of the severing station (27).

17. The apparatus according to claim 15, wherein the severing blade (53) is adjustable in the conveying direction for adaptation to different dimensions of the bags (10) which are to be produced, the severing blade forming an adjustable unit with the abutment blade (58).

18. The apparatus according to claim 7, further comprising a separate guide for sideways directed tapes (18) projecting beyond the sheet-material web (22) following the tape subassembly (36), the separate guide being a round belt (51) above the sheet-material web (22) in the region of the grip tab (19) of the tape (18), wherein a conveying strand of the round belt (51) butting against the top side or underside of the tape (18) in the region of the grip tab (19).

19. The apparatus according to claim 18, wherein the round belt (51) extends from the region of the tape subassembly (36), beyond the severing plane, into the region above a removal conveyor or bag conveyor (62) for removing the bags (10).

20. The apparatus according to claim 18, wherein the round belt (51) encircles the application roller (37) of the tape subassembly (36) in a peripheral guide groove (57) of the application roller (37), a horizontal conveying portion of the round belt (51) being provided by deflecting rollers (78, 79).
